(19) United States
(12) Patent Application Publication
(10) Pub. No.: US 2009/0034596 A1
(43) Pub. Date: Feb. 5, 2009

(54) Ethernet Traffic Emulation Using Ramped Traffic Generation Techniques

(75) Inventors: Wei Chen, Potomac, MD (US); Dave Fenstermacher, Mount Airy, MD (US); Hans-Joerg Wolf, Woodbine, MD (US); Olaf Herr, Reutlingen (DE)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: ACTERNA LLC, Germantown, MD (US)

(21) Appl. No.: 12/182,933

(22) Filed: Jul. 30, 2008

Related U.S. Application Data
(60) Provisional application No. 60/953,271, filed on Aug. 1, 2007.

(51) Int. Cl. H04B 17/00

(52) U.S. Cl. 375/224; 375/E07.279

(57) ABSTRACT

The invention relates to a testing system for generating a plurality of independently controllable streams of Ethernet frames, e.g. voice, data and video, in which the bandwidth utilization thereof can be held constant or ramped up to test the effects thereof on the other streams.

### CROSS-REFERENCE TO RELATED APPLICATIONS

The present invention claims priority from U.S. Patent Application No. 60/953,271 filed Aug. 1, 2007, which is incorporated herein by reference.

### TECHNICAL FIELD

The present invention relates to the testing of a common physical medium by the generation of multiple independent Ethernet traffic streams, and in particular by the simulation of various different types of streams, e.g. video, voice and data, which have ramped bandwidth utilization.

### BACKGROUND OF THE INVENTION

In a typical triple-play scenario, illustrated in FIG. 1, streams of Ethernet frames, e.g. video streams (IPTV ch1 and ch2), voice streams (VoIP call1 and call2), and data streams (HTTP and ftp) travel over a shared physical link, e.g. DSL or Ethernet. The Ethernet frames are classified based on their MAC addresses (source and destination), VLAN ID and priority (if VLAN present), and IP addresses (source and destination). All the parameters are encoded in various headers, including an Ethernet header and an IP header. A stream is a plurality of Ethernet frames with the same Ethernet and IP headers, i.e. the same parameters. Different streams may be assigned to different VLAN and have different priority in order to guarantee their respective QoS (quality of service). Typically, video and voice streams are given a higher priority than data, since there is a greater need for real time video and voice transmission.

The video, audio, or data streams, i.e. the Ethernet frames therein, are carrying video, audio, or data as their payload. From network operators point-of-view, the various streams are differentiated not only on the payload but also on the header parameters, because routers don't examine the payload. Accordingly, the only way to inform routers of which type of stream is being transmitted is to search the parameters in the header.

Conventional Ethernet testing devices, such as the one disclosed in U.S. Pat. No. 7,099,438 issued Aug. 29, 2006 in the name of Rancu, and United States Patent Publication No. 2005/0047333 published Mar. 3, 2005 in the name of Todd et al, rely on generating network traffic with a fixed bandwidth for testing typical network parameters. Unfortunately, a fixed bandwidth does not represent a typical network, in which various different types of traffic, e.g. video, data and VoIP, are constantly being added and dropped. Moreover, certain types of traffic, e.g. video, increase at certain times of day, thereby affecting the other types of traffic on the network.

An object of the present invention is to overcome the shortcomings of the prior art by providing a test system in which multiple, unrelated simulated Ethernet streams with variable parameters are used to test a triple play network by increasing, i.e. ramp up, the bandwidth utilization of one or more streams relative to the others.

### SUMMARY OF THE INVENTION

Accordingly, the present invention relates to a method for testing a physical link carrying Ethernet video, voice and data streams of frames to a customer with a guaranteed quality of service in order to determine a bandwidth utilization threshold at which the quality of service of the customer's Ethernet streams are affected comprising the steps of:

a) generating video, audio and data Ethernet streams in the physical link;

b) increasing the bandwidth utilization of a first of the video, audio and data Ethernet streams over a selected time interval;

c) receiving the video, audio and data Ethernet streams; and

d) determining whether the received video, audio and data Ethernet streams are within the guaranteed quality of service over the selected time interval;

whereby the bandwidth utilization threshold of the first Ethernet stream corresponds to the bandwidth utilization of the first Ethernet stream at the time the guaranteed quality of service is not met.

Another aspect of the present invention relates to a method for testing a physical link carrying Ethernet video, voice and data streams of frames to a customer in order to determine a bandwidth utilization threshold at which the customer's Ethernet streams are affected comprising the steps of:

a) generating video, audio and data Ethernet streams in the physical link;

b) setting the bandwidth utilization of a first and a second of the video, audio and data Ethernet streams to a constant amount;

c) increasing the bandwidth utilization of a third of the video, audio and data Ethernet streams over a selected time interval;

d) receiving the video, audio and data Ethernet streams; and

e) determining whether the first and second streams have been affected over the selected time interval;

whereby the bandwidth utilization threshold of the third Ethernet stream corresponds to the bandwidth utilization of the third Ethernet stream at the time the first or second stream has been adversely affected.

### BRIEF DESCRIPTION OF THE DRAWINGS

The invention will be described in greater detail with reference to the accompanying drawings which represent preferred embodiments thereof, wherein:

FIG. 1 is a schematic diagram illustrating the layers in a conventional TCP/IP model;

FIGS. 2a and 2b illustrate the testing arrangements for the present invention;

FIG. 3 illustrates a display screen with details of a plurality of different streams;

FIG. 4a is a plot of transmitter bandwidth vs time for two constant streams and one ramped stream;

FIG. 4b is a plot of receiver bandwidth vs time for two constant steams and one ramped stream with an service level agreement (SLA) to limit the data stream above a predetermined amount;

FIG. 5a is a plot of transmitter bandwidth vs time for two variable streams and one ramped stream; and

FIG. 5b is a plot of receiver bandwidth vs time for two variable steams and one ramped stream with an service level agreement (SLA) to limit the data stream above a predetermined amount.

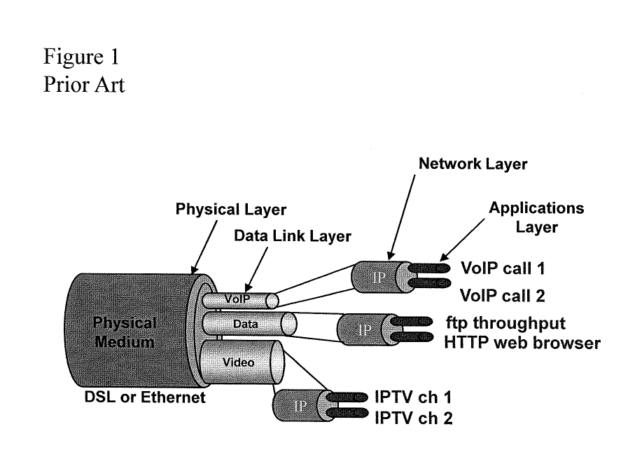

### DETAILED DESCRIPTION

The present invention is concerned with the testing of a network carrying Ethernet traffic with a plurality of different types of streams in order to determine the bandwidth utilization at which errors begin to occur. The testing technique is based on ramping, i.e. increasing the bandwidth utilization in time, in order to determine a threshold at which errors begin to occur. The test equipment according to the present invention has the capability of generating traffic that emulates several independent Ethernet streams with independently controllable parameters.

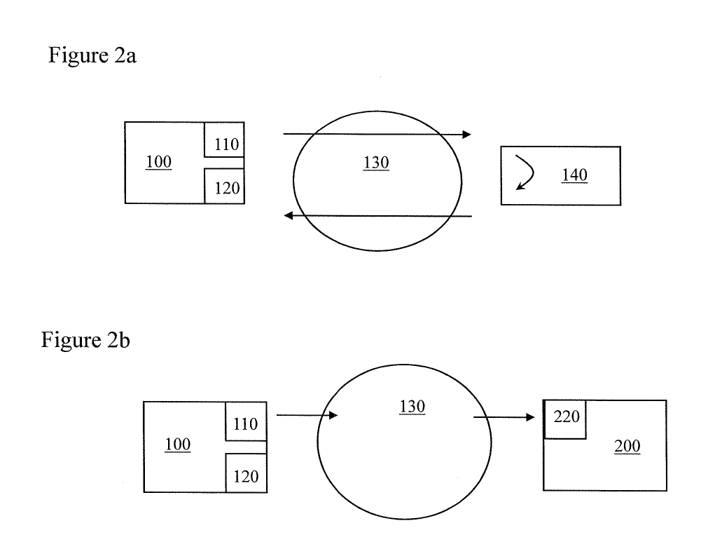

With reference to FIGS. 2a and 2b, the test equipment 100, according to the present invention, can be used to test the throughput/bandwidth utilization on an Ethernet connection in the following two configurations. In the first configuration (FIG. 2a), the Ethernet multiple streams of traffic are sent from a transmitter 110 in the test equipment 100 through a network 130 to a piece of network equipment 140, which loops the traffic back to and the same test equipment 100 for measuring the throughput/bandwidth on a receiver 120. In the second configuration (FIG. 2b), the first piece of test equipment 100 sends the Ethernet traffic using the transmitter 110 across the test network 130 to a receiver 220 in a second piece of test equipment 200.

The test equipment 100 includes a traffic engine implemented using a field programmable gate array (FPGA) for each stream. Each traffic engine is capable of generating frames/packets at a configurable rate/bandwidth. All the streams are then multiplexed at the transmitter 110. If a given stream is in the ramp mode, the rate/bandwidth of each traffic engine, under control of a micro-controller and suitable software provided in the test equipment 100, is incremented by a configurable step after a configurable time interval has elapsed. For a constant stream, the rate/bandwidth of the given engine can be configured once and never changed in the entire duration of the test.

Ideally, the test equipment 100 doesn't actually put video, audio, or data into the payload of the Ethernet test frames generated and transmitted by the transmitter 110, but rather places stuffing bytes instead. However, the test equipment 100 is able to configure the above-mentioned header parameters to represent video, audio, or data payloads, whereby “simulated” traffic is generated and transmitted by the test equipment 100, which the routers treat as actual video, voice and data steams. Instead of conventional stuffing bytes, an alternative packet format can be used containing packet parameters, e.g. sequence number, timestamp and checksum, whereby either a far-end unit or the receiver of the sending unit can measure packet delay, packet jitter (a.k.a. deviation of packet arrival time), lost packet, error packet, etc. For real time traffic such as VoIP and IP video, packet delay, packet jitter and packet loss are very important parameters in terms of quality of service (QoS).

The test equipment 100 also has the ability to independently increase, i.e. ramp up, the bandwidth utilization of each of the multiple streams to test the effects of an increase in the bandwidth of one type of stream on the others, and in particular determine bandwidth utilization thresholds for the various streams, which represent the maximum bandwidth utilization of one stream, e.g. data stream, before errors occur on another stream, e.g. audio and/or video streams. Each stream can have different ramp parameters, e.g. an incremental step and a time interval.

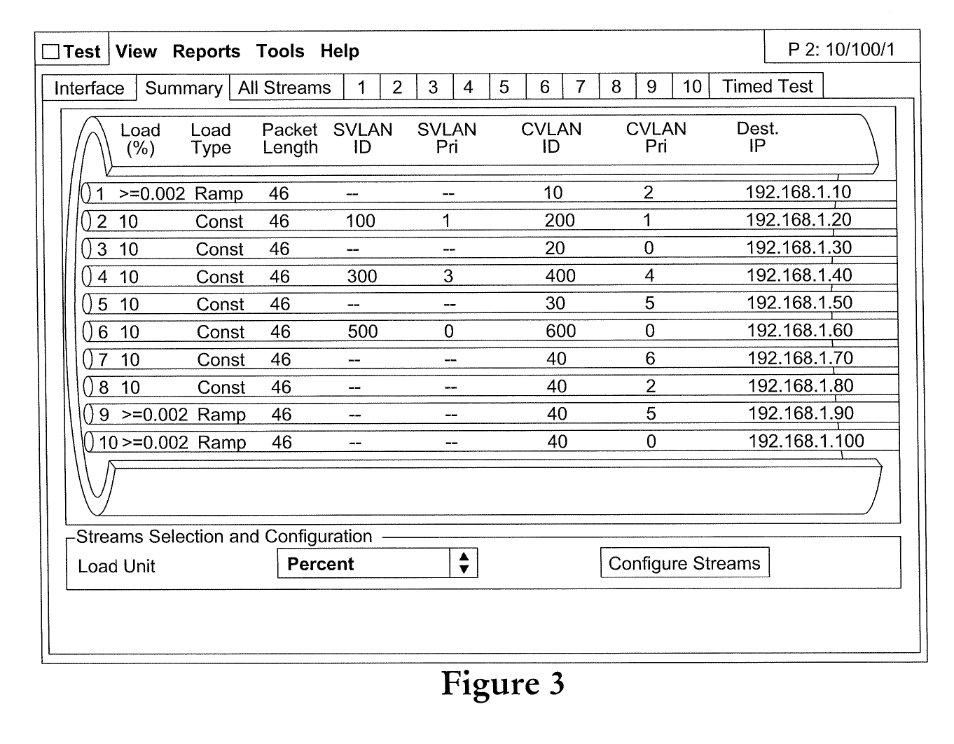

An increasing percentage bandwidth utilization traffic characteristic can be used to determine the thresholds at which the network begins to drop or corrupt traffic and/or generate PAUSE frames from several different types of streams, if full duplex flow control is supported. The technician (or a predetermined test configuration) will set the values for the incremental steps in percentage bandwidth utilization and the time intervals of each step for each stream. When a test is performed using the traffic generation selection, the transmitter can be set to stop transmitting and conclude the test when an error or PAUSE frame is received, enabling the bandwidth at which the problems began to occur to be determined. Typically, the test equipment 100 is capable of generating up to ten unique and independent streams, as illustrated in FIG. 3; however, any number of audio, video and data streams can be independently controlled in terms of their bandwidth utilization, i.e. either kept constant or ramped up.

The following parameter for each stream can be configured independently: MAC addresses (destination and source); Frame length in bytes; Frame encapsulation (namely, DIX, VLAN, or Q-in-Q); VLAN ID and priority; Q-in-Q ID and priority; IP addresses (destination and source); Packet length in bytes; Type of service; Traffic type (constant or ramp); Constant bandwidth; Ramp time step; and Ramp load step.

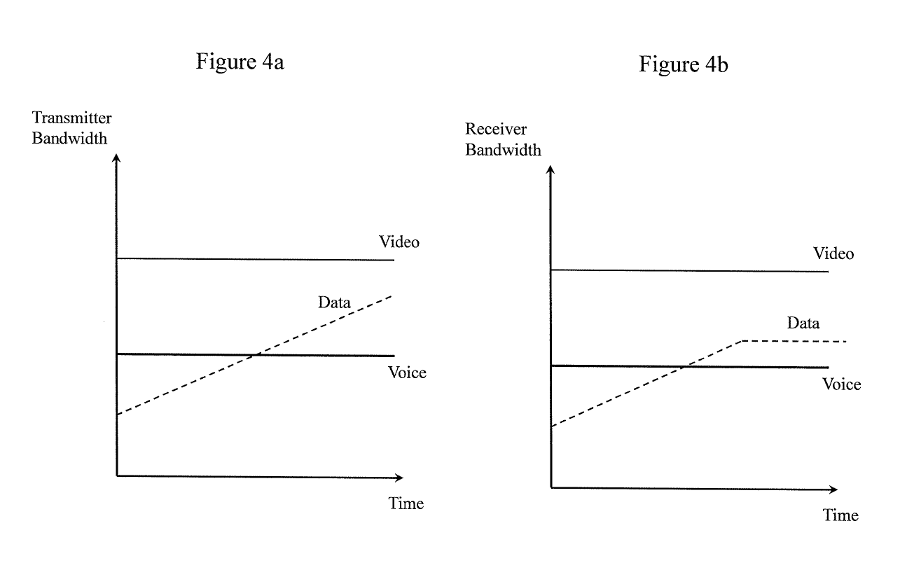

When the test equipment 100 is connected to a network or a piece of network equipment, e.g. a router, the transmit bandwidth can be compared with the receive bandwidth for each stream to verify if the guaranteed, e.g. via service level agreement (SLA), bandwidth is met for each stream. High priority is usually assigned to a video or an audio stream because those streams carry real-time traffic. Accordingly, the transmitter 110 transmits a “video” stream and an “audio” stream at their maximum guaranteed bandwidth, e.g. horizontal lines in FIGS. 4a and 4b, and then ramps up a “data” stream, e.g. angled dashed line in FIGS. 4a and 4b to verify the receive “video” and “audio” stream bandwidths are not changed, i.e. deleteriously effected, due to increasing “data” stream traffic. As illustrated in FIG. 4b, the testing equipment 100 can then determine the network limit of the “data” stream bandwidth by comparing the transmitted bandwidth to the received bandwidth, and in particular the horizontal portion of dashed line in the received bandwidth vs time graph, in order to guarantee the “video” stream and “audio” stream bandwidths if the network is appropriately configured and engineered. In this case, the test equipment 100 provides a means to verify a SLA.

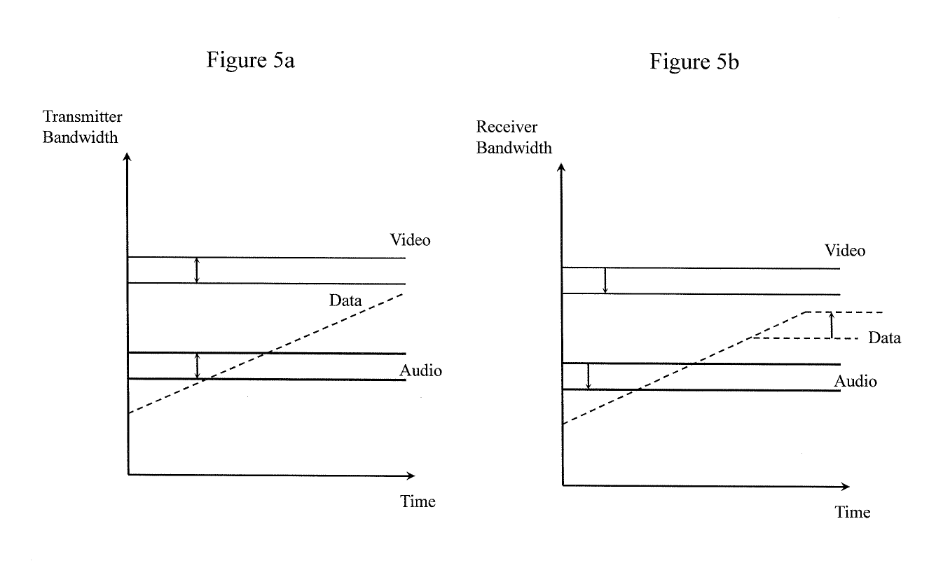

The video and audio streams can also be adjusted, as in FIG. 5a, to reflect differences in the traffic, i.e. video and audio bandwidth usage, to determine the correlation between the bandwidth level of the first two streams, e.g. video and audio, and the bandwidth limit, i.e. the maximum bandwidth utilization, of the third stream, e.g. data, prior to causing harm to the first and second streams. In particular, at certain times of the day or week, when the video and audio traffic is less than normal, e.g. minimized, the network can be tested to determine if the maximum bandwidth utilization of the data stream can be increased, as in FIG. 5b.

Although the preferred embodiment, including an MTS6000®, provides up to ten independent streams with independent header parameters and traffic mode, i.e. constant or ramp with independent ramping interval and step from other streams, the present invention can be extended to cover any number of independent streams with the same kind of independent configuration.

We claim:

1. A method for testing a physical link carrying Ethernet video, voice and data streams of frames to a customer with a guaranteed quality of service in order to determine a bandwidth utilization threshold at which the quality of service of the customer's Ethernet streams are affected comprising the steps of:
a) generating video, audio and data Ethernet streams in the physical link;
b) increasing the bandwidth utilization of a first of the video, audio and data Ethernet streams over a selected time interval;
c) receiving the video, audio and data Ethernet streams; and
d) determining whether the received video, audio and data Ethernet streams are within the guaranteed quality of service over the selected time interval;
whereby the bandwidth utilization threshold of the first Ethernet stream corresponds to the bandwidth utilization of the first Ethernet stream at the time the guaranteed quality of service is not met.

2. The method according to claim 1, wherein step a) includes generating simulated video, voice and data Ethernet streams utilizing stuffing bytes as payload, with video, voice and data stream header parameters.

3. The method according to claim 2, wherein the stuffing bits include one or more packet parameters selected from the group consisting of sequence number, timestamp and checksum, wherein the method further comprises: e) determining one or more of the parameters selected form the group consisting of packet delay, packet jitter lost packet and error packet.

4. The method according to claim 1, wherein step b) includes increasing the bandwidth utilization of the first stream by a predetermined amount at a predetermined time interval.

5. The method according to claim 4, further comprising shutting down the generation of Ethernet streams when the bandwidth utilization threshold is determined.

6. The method according to claim 1, wherein step d) includes determining whether the network begins to do any one or more of the following: drop traffic, corrupt traffic, and generate PAUSE frames.

7. The method according to claim 1, wherein step a) includes setting the bandwidth utilization of the voice and video streams to a predetermined amount; and wherein step b) includes increasing the bandwidth utilization of the data stream.

8. The method according to claim 1, wherein steps a) includes transmitting video, audio and data Ethernet streams from a test device to a remote piece of equipment, which sends the video, audio and data Ethernet streams back to the test device.

9. The method according to claim 1, wherein step a) includes transmitting a plurality of video streams, a plurality of audio streams and a plurality of data Ethernet streams.

10. A method for testing a physical link carrying Ethernet video, voice and data streams of frames to a customer in order to determine a bandwidth utilization threshold at which the customer's Ethernet streams are affected comprising the steps of:
a) generating video, audio and data Ethernet streams in the physical link;
b) setting the bandwidth utilization of a first and a second of the video, audio and data Ethernet streams to a constant amount;
c) increasing the bandwidth utilization of a third of the video, audio and data Ethernet streams over a selected time interval;
d) receiving the video, audio and data Ethernet streams; and
e) determining whether the first and second streams have been affected over the selected time interval;
whereby the bandwidth utilization threshold of the third Ethernet stream corresponds to the bandwidth utilization of the third Ethernet stream at the time the first or second stream has been adversely affected.

11. The method according to claim 10, wherein step a) includes generating simulated video, voice and data Ethernet streams utilizing stuffing bytes as payload, with video, voice and data stream header parameters.

12. The method according to claim 11, wherein the stuffing bits include one or more packet parameters selected from the group consisting of sequence number, timestamp and checksum, wherein the method further comprises: f) determining one or more of the parameters selected form the group consisting of packet delay, packet jitter lost packet and error packet.

13. The method according to claim 10, wherein step e) includes determining whether the network begins to do any one or more of the following: drop traffic, corrupt traffic, and generate PAUSE frames.

14. The method according to claim 10, wherein step a) includes setting the bandwidth utilization of the voice and video streams to a predetermined amount; and wherein step b) includes increasing the bandwidth utilization of the data stream.

15. The method according to claim 10, wherein steps a) includes transmitting video, audio and data Ethernet streams from a test device to a remote piece of equipment, which sends the video, audio and data Ethernet streams back to the test device.

16. The method according to claim 10, wherein step a) includes transmitting a plurality of video streams, a plurality of audio streams and a plurality of data Ethernet streams.

17. The method according to claim 10, further comprising:
increasing the bandwidth utilization of the first and the second of the video, audio and data Ethernet streams; and
repeating steps c) to e).
